(19) United States
(12) Patent Application Publication
(10) Pub. No.: US 2008/0089829 A1
(43) Pub. Date: Apr. 17, 2008

(54) In-situ back-contact formation and site-selective assembly of highly aligned carbon nanotubes

(75) Inventors: Ramanath Ganapathiraman, Clifton Park, NY (US); Saurabh Agrawal, Troy, NY (US); Matthew J. Frederick, Madison, NJ (US); Raghuveer Makala, Santa Clara, CA (US)

Correspondence Address: FOLEY AND LARDNER LLP;SUITE 500, 3000 K STREET NW, WASHINGTON, DC, 20007, US

(73) Assignee: RENSSELAER POLYTECHNIC INSTITUTE

(21) Appl. No.: 11/580,279

(22) Filed: Oct. 13, 2006

(51) Int. Cl. B82B 3/00; D01F 9/12; D01C 5/00

(52) U.S. Cl. 423/447.3; 977/843

(57) ABSTRACT

Controllably aligned carbon nanotubes are grown, without the use of a predeposition catalyst, on electrically conducting templates that form an electrical contact with the nanotubes. The method allows fabrication of nanotube-based devices with built-in back-side electrical contacts on silicon and other substrate surfaces.

The invention was made with Government support under grant numbers DMR 9984478, DMI-0304028 and C-040110 awarded by the National Science Foundation.

### BACKGROUND OF THE INVENTION

The present invention relates generally to carbon nanotubes and more particularly to selective growth of carbon nanotubes on template materials.

Carbon nanotubes (CNTs) are promising materials for nanodevices due to their attractive optical and electronic properties arising from their unique molecular shape, size and structure. A number of optical and electronic device concepts have been proposed and demonstrated using individual CNTs. See E. Braun & K. Keren, Adv. Phys. 53, 441 (2004); J. Lee et al., Appl. Phys. Lett. 79, 1351 (2001); R. Hillenbrand et al., Appl. Phys. Lett. 83(2), 368 (2003); Y. Huang et al., Science 294, 1313 (2001); X. Duan, et al., Nature 421, 241 (2003); Y. Cui et al., Science 293, 1289 (2001); J. Kong et al. Science 287, 622 (2000); S. J. Tans et al., Nature 393, 49 (1998). But in order to translate these concepts into actual CNT-based device architectures, e.g., forming CNTs on a silicon substrate for facile interfacing through optical or electronic signals, it is crucial to devise scaleable methods that selectively place and orient CNTs and form electrical contacts on device substrates, such as Si-based substrates. Contacts are usually formed by dispersing CNTs on electrode patterns formed by lithography, or depositing metal patterns on CNTs by ion-beam assisted writing. These techniques, however, are not easily amenable to form bottom- or back-contacts, i.e., forming the electrodes at the root of aligned CNT bundles or films.

Recent work has demonstrated the site-selective growth of oriented CNTs. See B. Q. Wei et al., Nature, 416, 495 (2002); S. Fan et al., Phys. E., 8, 179 (2000). However, formation of electrical back-contacts and bottom-contacts to architectures comprised of aligned CNTs on planar substrates, such as Si, remains a major challenge. For example, in cases where vertically aligned CNTs are grown on conducting metal catalyst films, reliable back-contact formation is difficult because CNT growth requires nanoparticle formation by ion- or laser-irradiation-induced dewetting and agglomeration, which can render the film discontinuous and compromise the integrity of both the CNT alignment and the electrical contact. See M. Yudasaka et al., Appl. Phys. Lett. 67(17), 2477 (1995); C. W. Chao et al., J. Electrochem. Soc. 150(9), C631 (2003); A. M. Cassell et al., Appl. Phys. Lett. 85, 2364 (2004); H. T. Ng et al., J. Phys. Chem. B 107, 8484. (2003).

Accordingly, there is currently a need in the art for techniques that achieve a reliable electrical back- and/or bottom-contact of aligned CNTs on planar substrates, such as Si, without requiring a predeposited metal catalyst layer.

### SUMMARY OF THE INVENTION

An embodiment of the present invention provides a substrate that is not coated with a metal catalyst layer, a porous metal oxide layer located on the substrate, and a plurality of carbon nanotubes that extend through the pores of the metal oxide layer. The porous metal oxide layer is adapted to comprise an electrically conductive electrode which electrically contacts the carbon nanotubes.

### BRIEF DESCRIPTION OF THE DRAWINGS

FIGS. 1A-B, 1D, and 7A-D are SEM images of carbon nanotube structures according to preferred embodiments of the present invention.

FIG. 1C is an optical micrograph of carbon nanotube structures according to preferred embodiments of the present invention.

FIG. 2A is a plan-view bright-field TEM image of an ITO template structure according to a preferred embodiment of the present invention.

FIG. 2B is a histogram of pore-width distribution of an ITO template structure according to a preferred embodiment of the present invention.

FIGS. 3A-D and 6A-B are side cross sectional schematic views of carbon nanotube structures according to preferred embodiments of the present invention.

FIG. 4A is a plot of measured current versus an applied voltage according to a preferred embodiment of the present invention.

FIG. 4B is a plot of measured differential conductance versus an applied voltage according to a preferred embodiment of the present invention.

FIG. 4C is a plot of measured differential conductance versus an electric field according to a preferred embodiment of the present invention.

FIG. 5A is a plot of measured conductivity versus inverse temperature according to a preferred embodiment of the present invention.

FIG. 5B is a plot of measured conductivity versus an electric field according to a preferred embodiment of the present invention.

FIG. 5C is a plot of activation energy versus an electric field according to a preferred embodiment of the present invention.

### DETAILED DESCRIPTION OF THE PREFERRED EMBODIMENTS

The present inventors have developed a method of providing built-in electrodes at the root of carbon nanotubes (CNTs) grown on solid substrates. The method obviates the requirement of predepositing a metal catalyst layer that seeds CNT growth. A porous metal oxide layer is deposited on a substrate comprising a surface that facilitates the growth of CNTs nucleating at or near that surface without the use of a metal catalyst layer. The CNTs extend through the pores in the porous metal oxide layer. In one aspect of the invention, the porous metal oxide layer is made of an electrically conducting material such as indium tin oxide (ITO) or ZnO. Alternatively, the porous metal oxide layer is electrically insulating and is reduced to result in an electrically conducting layer, as will be explained below. Simultaneous growth of both vertically and horizontally controllably aligned CNTs with built-in electrical contacts in a single process step is possible with multisided template structures.

A template structure is a structure, pattern, or material which allows selective growth of carbon nanotubes on or through it without growing any detectable amount of carbon nanotubes on exposed portions of a substrate not covered by the template structure. A template may comprise the entire surface of a substrate, as in the case of SiO₂ (glass) substrates or a layer over a substrate, so as to facilitate nanotube nucleation and growth on the entire substrate surface. A template may comprise a portion of the surface of a substrate, such as silicon oxide templates that are patterned or selectively grown on a Si(001) substrate. CNTs grow normal to, and selectively on the surface of the template structure, inheriting the topography of the surface. Thus, the nanotubes are controllably aligned in a direction perpendicular to the surface of the template structure from which they grow such that all the nanotubes which grow from a particular template structure surface are oriented in the same direction. The precise control of nanotube orientation allows the fabrication of a wide variety of organized architectures of differing complexities, shapes, densities, dimensions and orientation. The bottom up fabrication approach is easy, scalable, and compatible with silicon microfabrication techniques and processes.

In a preferred aspect of the present invention, a metal oxide layer is deposited on a silicon oxide template structure, which is located on a silicon substrate. CNT growth occurs from the surface of the silicon oxide template structure and extends through the pores in the metal oxide layer. In another preferred aspect of the present invention, the metal oxide layer is deposited directly on the silicon substrate, which forms an interfacial silicon oxide layer between the metal oxide and the substrate. CNTs nucleate at or near the surface of the interfacial silicon oxide layer and extends through the pores in the metal oxide layer. However, other suitable template and substrate materials may be used instead. Thus, a carbon nanotube growth catalyst material, such as a metal catalyst layer, is not necessary to selectively grow carbon nanotubes, and is preferably omitted to simplify processing. In alternative aspects of the present invention, a metal that does not catalyze nanotube growth, such as gold or copper, can also be used to mask part of the template structure such that CNT growth does not occur on masked portions of the surface.

In preferred embodiments of the present invention, controllably aligned multiwalled carbon nanotubes are selectively and simultaneously grown in patterns and in multiple directions on lithographically-patterned silicon oxide templates, which are covered with a porous metal oxide layer, in a single process step. This process is preferably carried out through a CVD “floating catalyst” method that delivers the nanotube-forming precursor, such as xylene, and the catalyst material (in compound or elemental form), such as ferrocene, from the gas phase. This precursor chemistry is known to result in oriented CNT growth selectively on insulating surfaces such as SiO₂ and Al₂O₃, see Z. J. Zhang et al., Appl. Phys. Lett. 77, 3764 (2000); I. Radu et al., Nanotechnology, 15, 473 (2004), in exclusion to non-oxide surfaces (e.g. Au, Si), see A. Cao et al., Adv. Mater, 15, 1105 (2003). Preferably, the pores in the metal oxide layer allow the precursor to access the surface of the silicon oxide template, from which the CNTs nucleate and grow oriented normal to the surface through the pores in the porous metal oxide layer.

The specific examples of nanotube structures of the present invention shown are illustrated in SEM images in the Figures. However, the present invention should not be considered limited by the structures and methods of the specific examples, which are provided for illustration of the present invention.

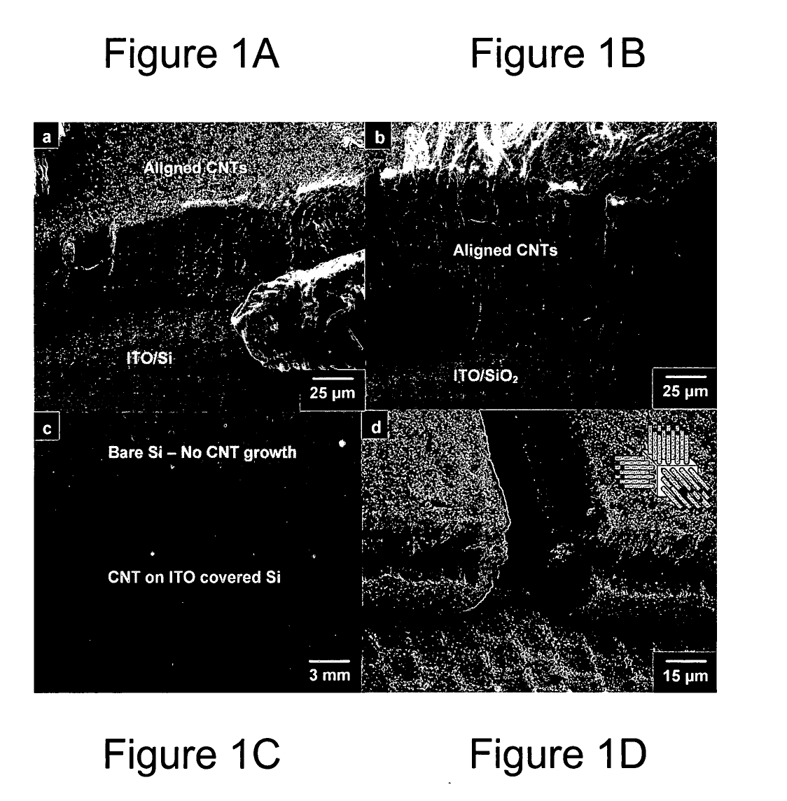

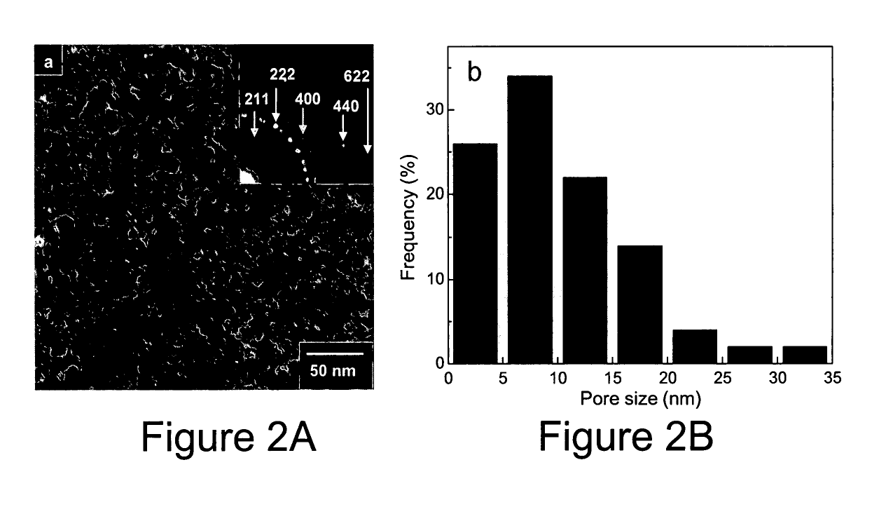

The nanotube structures shown in the SEM images in FIGS. 1A-D were selectively grown on device quality Si(001) wafers with, and without, a 650-nm-thick thermally grown SiO₂ layer. These were cleaned successively in ultrasonic baths containing trichloroethylene, acetone and isopropyl alcohol. ITO films was deposited on the Si wafers and on the SiO₂-coated wafers by DC magnetron sputtering (chamber base pressure ˜10⁻⁹ Torr) of a 99.99% pure In₂O₃ 10 atomic % SnO₂ target with 50 W power in a 5 mTorr Argon plasma. The deposition rate was ˜2.7 nm/min, and the film thickness was controlled to between 40 to 120 nm by adjusting the deposition time. The substrates were placed into a 120-cm-long quartz-tube chemical vapor deposition (CVD) furnace, which was then evacuated to ˜10-³ Torr, and heated to 775° C. After preheating the substrate for ˜30 minutes to allow nucleation of an interfacial SiO₂ layer on the non-coated Si wafers, a mixture of 0.4 g xylene in 40 ml ferrocene was vaporized in a stainless steel ampoule at 210° C., and introduced into the CVD furnace with a 100 sccm Ar stream.

The morphology of the CNTs was characterized by scanning electron microscopy (SEM) in JEOL 6330F FESEM microscope operated at 5 kV. X-ray photoelectron spectroscopy (XPS) measurements of the ITO layers revealed a film composition of In₂O₃ containing 21.5 atomic % SnO₂, which is tin-rich due to preferential sputtering of Sn. The ITO film microstructure and the ITO/Si interface were characterized the by cross-sectional TEM (XTEM) using a Philips CM 12 microscope operated at 120 kV. Electron-transparent cross-sections of ITO/SiO₂ bilayers were obtained by etching the samples at 77 K with a 5 kV 8.5 mA Ar⁺ion beam in a Fishione 1010 LAMP system.

The CVD process of the above-described embodiment resulted in the growth of CNTs on 40-nm-thick ITO films coated on either bare Si or SiO₂-capped Si substrates. This is seen in FIGS. 1A and 1B, respectively, which show dense bundles of CNTs. Irrespective of whether the ITO templates were deposited on bare Si substrates or SiO₂-capped Si substrates, the CNTs were aligned and oriented in a direction normal to the ITO film surface. No CNT growth was observed over regions of bare Si that were not covered by ITO (see FIG. 1C), indicating site-selective CNT growth on substrate surfaces comprising interfacial oxide layers or silicon oxide templates. Site-selectivity and oriented growth can be harnessed to obtain multidirectional CNT architectures with a built-in back-contact by creating ITO surfaces of differing orientations with respect to the Si substrate surface. FIG. 1D shows an exemplary structure with both vertically and horizontally oriented CNT bundles grown selectively on ITO covered regions of Si mesa patterns in the field areas, and on the sidewalls, respectively. Thus, the CNTs can constitute bundles aligned in different directions.

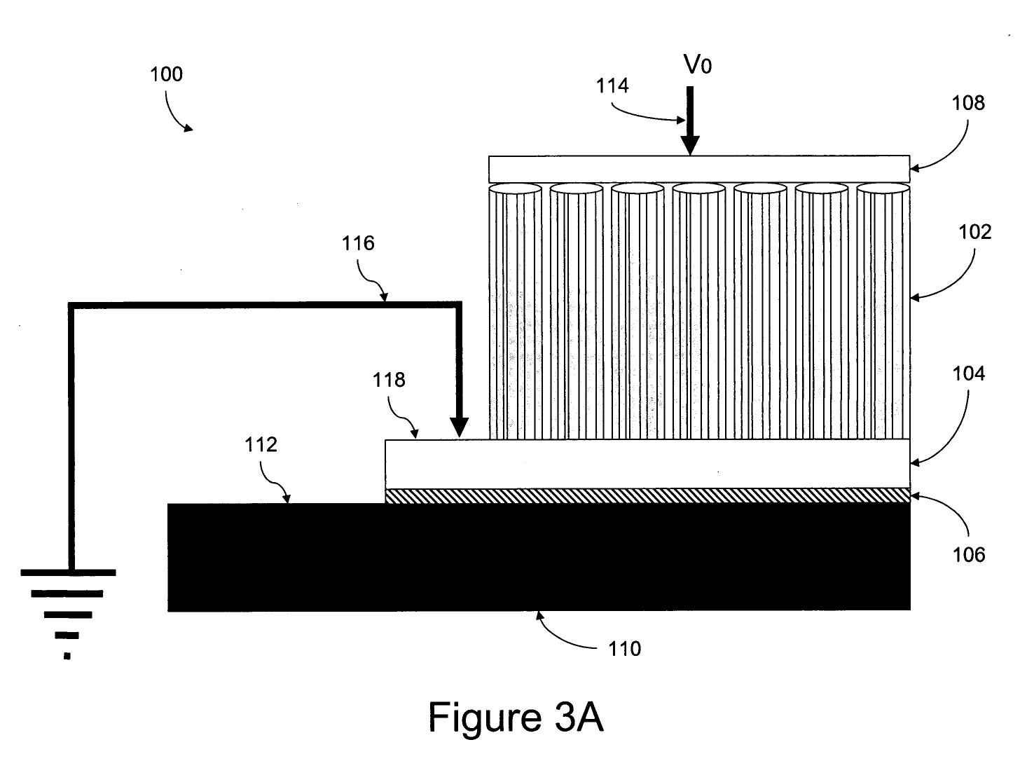

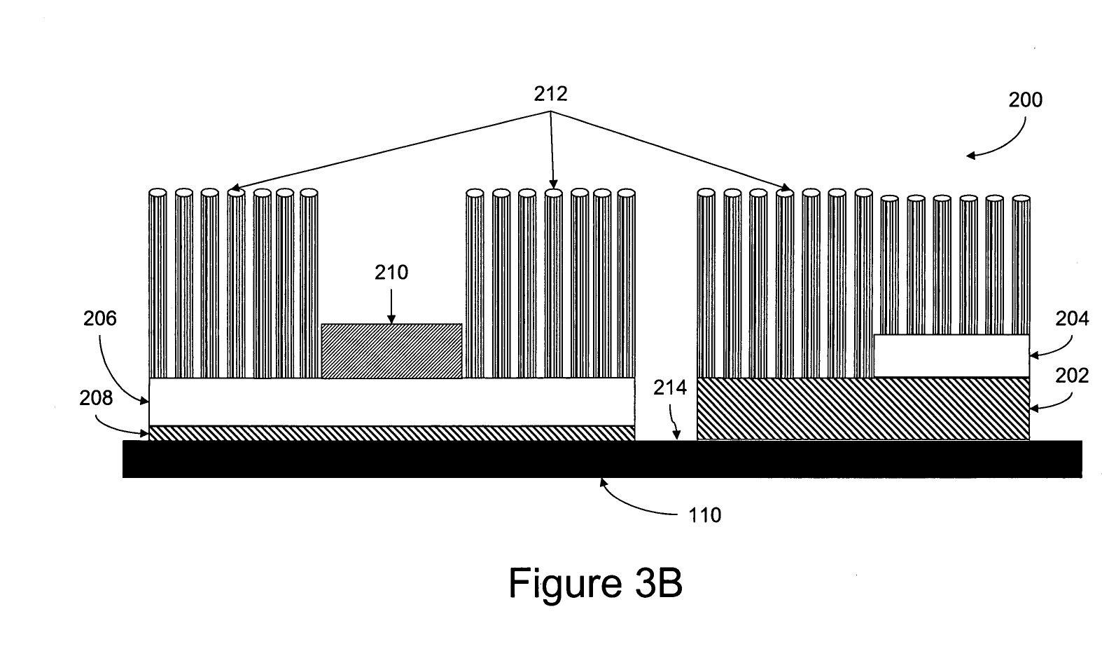

The above CVD process did not produce any CNT growth on ITO films having a thickness greater than approximately 120-nm on either bare Si(001) or SiO₂-capped Si. Performing the CVD process on a 40-nm-thick ITO film deposited on gold did not yield any observable CNT growth. This result suggests precursor diffusion through the ITO and CNT nucleation at or near the ITO/substrate interface. Although the exact location of where the nanotube nucleation occurs cannot be visually ascertained, plan-view TEM measurements of the ITO layer prior to nanotube growth showed an intergranular network of ˜5-20 nm-wide pores (see FIGS. 2A and 2B). Nanotubes are presently understood to be disposed on a substrate surface and extend through the oxide pores so long as nanotube growth is observed extending above the metal oxide layer. Thicker ITO films presumably block the access of the precursors to SiO₂ layer and inhibit CNT growth. Thus, ITO film thickness is preferably less than 120 nm, preferably about 40 nm or less. In another embodiment, the template material is a metal oxide other than ITO, such as other electrically conductive, optically-transparent metal oxides, including ZnO, SnO, AZO (aluminum zinc oxide). For different template materials, the template thickness is varied to determine the maximum thickness which promotes CNT growth, which is a function of the template properties, e.g., pore size, diffusivity, etc. The metal oxide layer thickness is preferably sufficiently thin to allow precursor diffusion through the substrate, yet sufficiently thick to provide a good electrical contact to the CNTs.

Furthermore, substrates other than Si can be used. Other semiconductor or non-semiconductor substrates may be used. For example, transparent substrates, such as glass, quartz, etc., may be used for display devices.

Since CNTs generally do not grow on bare Si surfaces by the floating catalyst CVD process, CNT growth on ITO/Si(001) suggests that the Si substrate surface is oxidized by an interfacial reaction with the ITO overlayer. This reaction is thermodynamically favorable at 775° C., and the 5 to 8 nm-thick SiO₂ layer known to form in this temperature range, see C. W. Ow-Yang et al., App. Phys. 88(6), 3717 (2000) (ΔG_{f}^{In}₂^{O}₃^{,785° C.}=−588.78 kJ mole⁻, ΔG_{f}^{SiO}₂^{,785° C.}=−719.34 kJ mole⁻¹), is greater than the critical value necessary for CNT growth, see A. Cao et al., Appl. Phys. Lett. 84(1), 109 (2004). The thinner interfacial silica layer in ITO/Si(001) structures, compared to the 650-nm-thick SiO₂ in ITO/SiO₂/Si(001) structures, results in a 60% lower CNT growth rate than on the ITO/SiO₂/Si(001) structures, and is consistent with SiO₂-thickness-dependence of CNT growth rate reported recently by A. Cao et al., Appl. Phys. Lett. 84(1), 109 (2004). The reduction of ITO by Si is further supported by four-point probe measurements of ITO/Si(001) and ITO/SiO₂/Si(001) structures. Annealing ITO/Si structures at the CVD growth temperature without introducing the precursors resulted in a ˜45% sheet resistance decrease from ˜55 to 30 Ω/sq-due to oxygen depletion from ITO during reduction by Si. These results indicate that the method of the present invention can be extended to forming contacts to CNTs using porous metal oxide layers of even insulating materials which, upon reduction by the substrate material or by the substrate coating material, results in an electrically conducting metal oxide layer. For example, metal oxides, such as ZnO, Cu₂O, and Li₂O, or their alloys, which can be reduced by Si below the CVD temperature, may be used to form contacts with partially reduced conducting oxides (e.g., ZnO) or completely reduced metals (e.g., Cu). For instance, in one embodiment, a substrate material and template material are chosen such that the template material can be reduced by the substrate material. It is known that various metal oxides are thermodynamically less stable than SiO₂ (e.g., In₂O₃, SnO₂, ZnO, PbO₂, SeO₂, NbO₂, Ni₂O₃, MoO₂ and their alloys). These oxides range from electrically and optically active materials, to electrically insulating dielectric materials, which allows CNT growth on high-k and transparent conducting oxides to enable new, potentially revolutionary, device concepts. For instance, devices may use CNTs as gate electrodes, or as components that enable microwave signal detection. The unique thermal-/photo-stimulated electrical responses of CNT-oxide structures can be harnessed for interconnection, on-chip communication, and thermal management.

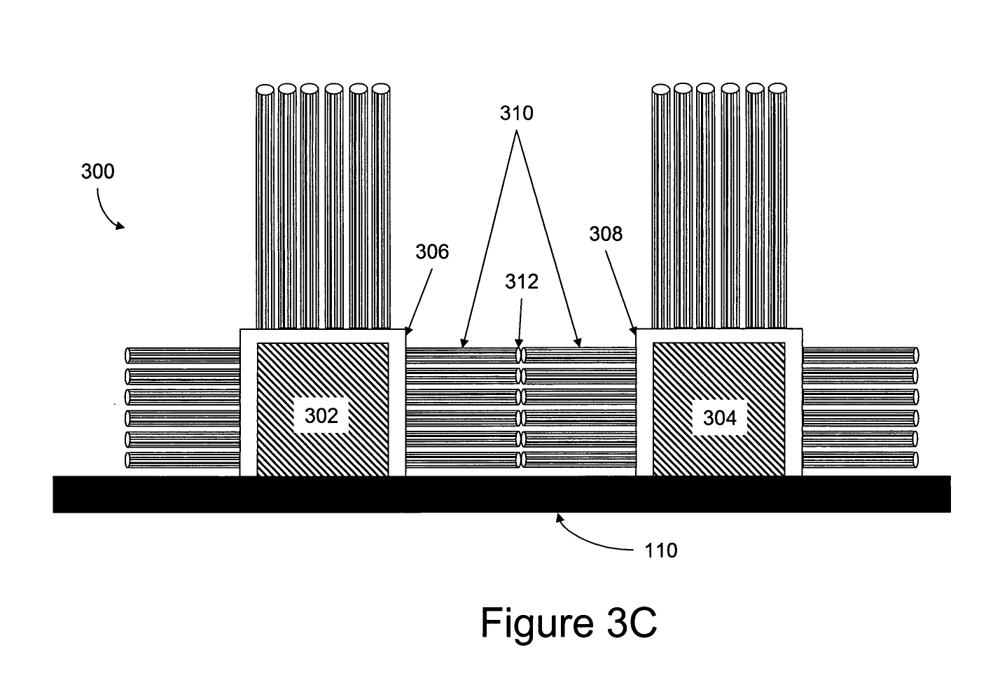

FIGS. 3A-B show structures of the present invention in order to merely demonstrate some of the wide variety of structures that can be fabricated with the present invention. FIG. 3A shows a device according to one embodiment of the present invention. The device 100 includes a plurality of vertically aligned multiwalled CNTs 102, located on a porous ITO template layer 104, located on a SiO₂ template layer 106. The SiO₂ template layer 106 is formed by thermal growth or by plasma enhanced chemical vapor deposition (PECVD). Alternatively, the ITO template layer 104 is deposited on a bare Si(001) substrate 110, and the SiO₂ template layer 106 is formed as an interfacial oxide layer between the ITO template 104 and the Si(001) substrate 110 during ITO or CNT deposition or during a preheating step in which the interfacial oxide is formed at 775° C. after 30 min. Patterns of SiO₂ and ITO layers of various shapes are generated by photolithography followed by a combination of wet and/or dry etching. The thickness of the CNTs 102 was ˜100 ˜m. A 200 nm thick Pt top contact 108 was sputter-deposited on the aligned CNTs 102. The substrate 110 was a device-quality Si(001) wafer, and no CNT growth was visible on an exposed surface 112 of the Si(001) wafer that was neither capped with either or both the SiO₂ layer 106 or the ITO layer 104. Electrical measurements were carried out immediately after preheating the device 100 to 150° C. in air and then cooling to room temperature. Electrical contact between the ITO layer 104 and the CNTs 102 is unlikely to be caused by Pt atoms from the Pt top contact 108 because sputtering is a physical-vapor-deposition process in which the atomic sticking coefficient is close to unity. Therefore, penetration of a refractory metal such as Pt through the CNTs beyond 1-2 nm, either during deposition or by diffusion, is highly unlikely. See G. Ramanath et al., J. Appl. Phys. 85, 1961 (1999). An applied voltage (V₀), which was applied via a first probe 114 contacting the Pt top contact 108, was referenced to a ground voltage through a second probe 116. The second probe 116 contacted a surface 118 of the ITO layer 104 where no CNTs were present. The uncovered surface 118 is formed, for example, by removing CNTs (via, e.g., etching or polishing) from a portion of the ITO layer, or by masking a portion of the ITO layer 104 with a non-catalytic material (e.g., gold), or by covering the sidewalls of the SiO₂ template layer 106 with ITO wherein the thickness of the SiO₂ template layer is less than the critical thickness necessary for nanotubes to grow from the sidewalls of the template structure (such as less than 1 micron, preferably less than 200 nm or less for SiO₂). Optionally, the CNTs are bombarded with ions (>1 keV) to modify the surfaces and/or tailor the properties of the CNTs, for instance to anneal defects or to modify the nature of the CNT/oxide interface.

FIG. 3B shows a plurality of structures 200 located on the same Si(001) substrate 110. A first SiO₂ template layer 202 is formed on the substrate 110 by PECVD and photolithography patterns. The thickness of this layer is controlled via the deposition time and other parameters. For instance, the thickness is controlled to be less than the critical thickness necessary for nanotubes to grow on side surfaces of the SiO₂ template layer (less than 1 micron, preferably less than 200 nm). DC magnetron sputtering is used to controllably pattern a first porous ITO template layer 204 on a portion of the first SiO₂ layer 202. Concurrently, a second porous ITO template layer 206 is controllably patterned on a portion of the Si(001) substrate that is not capped by the first SiO₂ layer 202. At temperatures near 775° C., the formation of an interfacial SiO₂ layer 208 between the ITO layer 204 and the substrate 110 is thermodynamically favorable and is preferably between 5 and 8 nm thick. Optionally, a mask layer 210 of a non-catalytic masking material (e.g., gold) is deposited on a portion of the second ITO template layer 206. For example, the nominal thickness of the gold mask layer is 20 nm. A mixture of xylenes/ferrocene gas is introduced into a CVD tube furnace at a temperature ranging from 600 to 1100° C. Bundles of multi-walled carbon nanotubes 212 grow selectively and simultaneously on the first SiO₂ layer 202, through the pores of the first ITO template layer 204, and through the pores of the second ITO template layer 206, but not on the mask layer 210 or on the exposed portions 214 of the Si(001) substrate. The growth rates of the CNTs differ depending on the template structure. As discussed previously, the thinner interfacial silica layer in ITO/Si(001) structures, compared to the thick SiO₂ in ITO/SiO₂ structures, results in a 60% lower CNT growth rate. Therefore, with a given flux of xylenes/ferrocene gas, the CNTs 212 will possess different heights with respect to the substrate surface, which may optionally be leveled to equal heights by polishing, etching, or ion bombardment. Optionally, the ITO layers are doped or otherwise treated so as to alter the growth rate of the CNTs or the nature of the electrical contacting of the CNTs. Optionally, a Pt top contact layer is deposited on one or more portions of the tops of the CNT bundles 212 for accessing the electrical, optical, or thermal properties of the CNT bundles. Therefore, CNTs of different height may be formed over the substrate during the same deposition step.

FIG. 3C shows a plurality of structures 300 located on the same Si(001) substrate 110. A first and second SiO₂ template structures 302, 304 are patterned at predetermined distances from each other, with opposite sidewalls parallel to and facing each other. For instance, the SiO₂ template structures 302, 304 are substantially cubic in shape and possess thicknesses above the substrate 110 that are greater than the critical thickness necessary for nanotubes to grow from the sidewalls of the template structure (greater than 200 nm, preferably greater than 1 micron). A first and second ITO template layer 306, 308 is deposited on all five sides of the first and second SiO₂ template structures 302, 304, respectively. Optionally, at least one of the five sides of the template structures 302, 304 is masked with an optional masking layer. For instance, the substrate 110 containing the template structures 302, 304 is placed into a sputtering apparatus and is tilted at 15 to 40 degrees relative to an incident sputtering beam, such that a gold masking layer is selectively sputtered onto an upper surface and at least one side surface of template structures 302, 304. Alternatively, the masking layer can be deposited only at desired locations by using a shadow mask, or through lift-off lithography techniques. Similarly, the ITO template layers 306, 308 optionally cover less than all five surfaces of the template structures 302, 304. Alternatively, one or more surfaces of the ITO template layers 306, 308 is covered with a masking layer. A mixture of xylenes/ferrocene gas is introduced into a CVD tube furnace at a temperature ranging from 600 to 1100° C. Bundles of multi-walled CNTs grow selectively and simultaneously on the ITO template layers 306, 308 and the SiO₂ template structures 302, 304, but not on exposed areas of the substrate 110 or on the optional masking layer. CNTs growing in opposite directions 310, towards each other between patterns, cease to grow when they meet each other and form CNT-CNT interfaces 312. Template structures are not limited to structures of cubic shapes. For instance, the SiO₂ and ITO structures can be cylindrical, possess side surfaces with oblique inclinations, comprise a membrane having an open truncated cone shape, or comprise other shapes. For instance, the ITO-covered Si mesa pattern in FIG. 1D facilitated the growth of CNTs in three orthogonal directions.

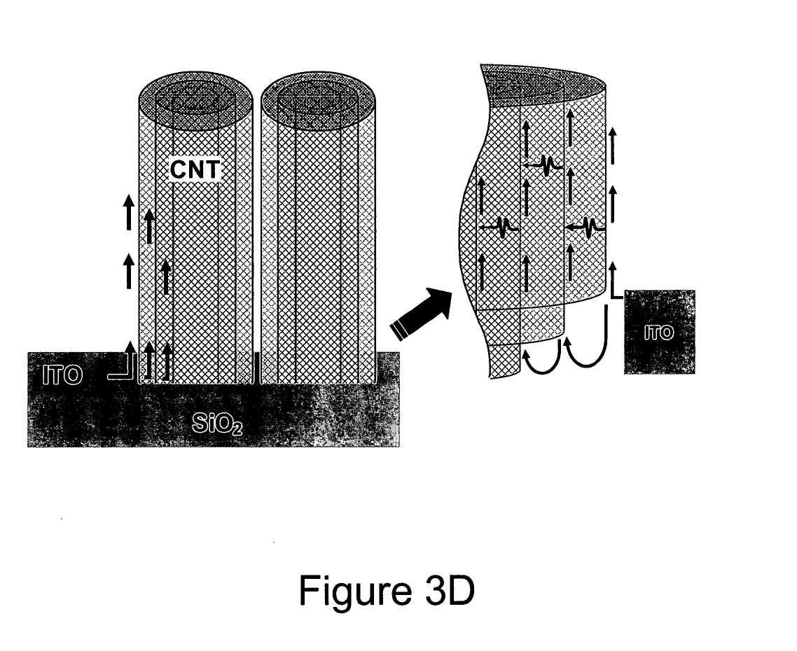

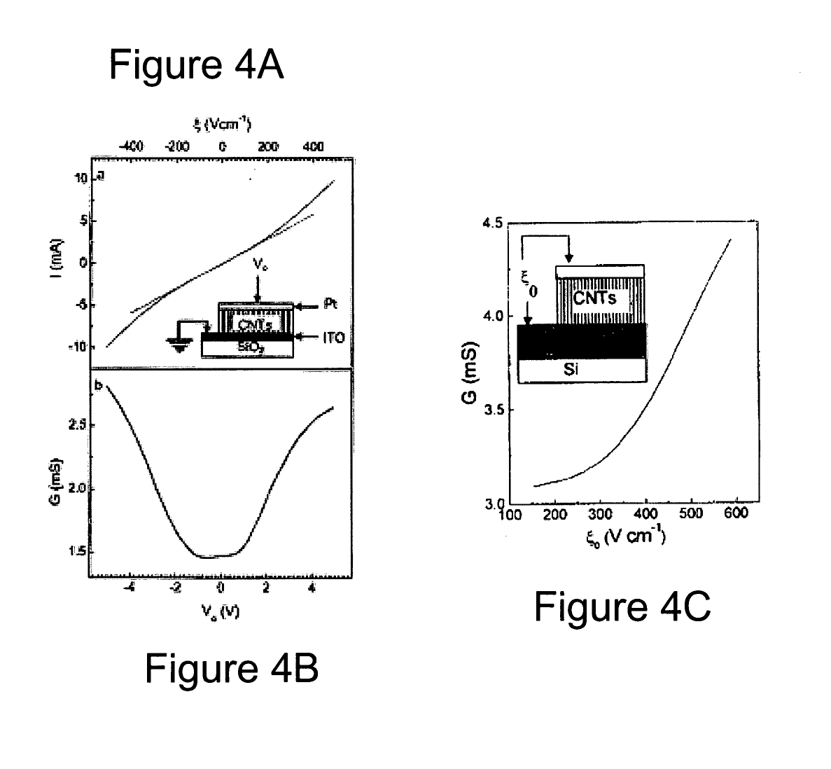

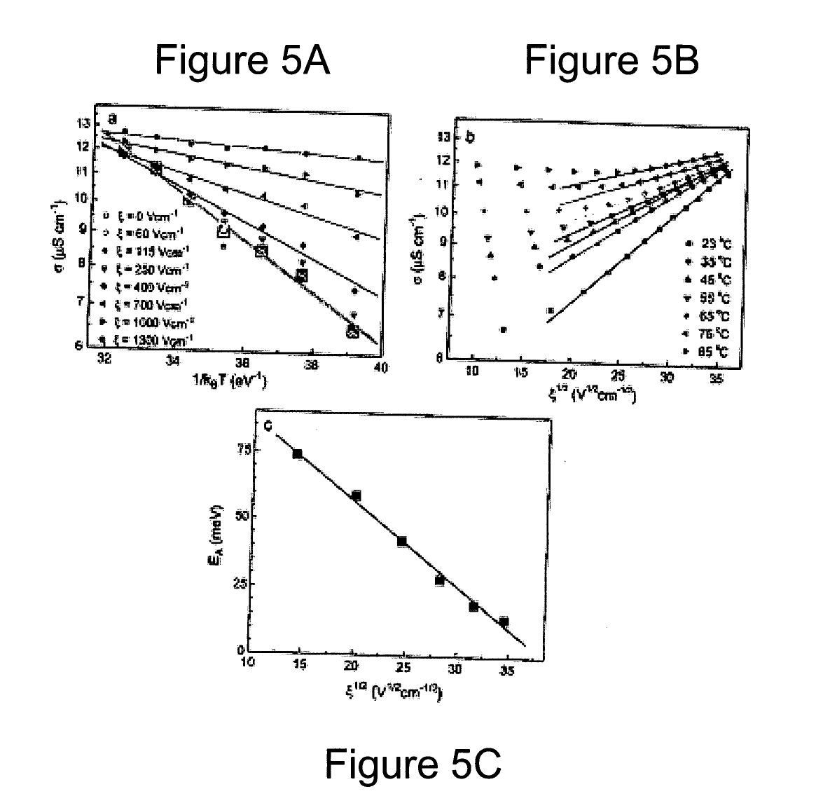

FIG. 3D is a schematic example of the electrical contacting that facilitates carrier transport between a multiwalled carbon nanotube and a porous metal oxide layer, such as ITO. The highest resistance in the test device of FIG. 3A, and hence the major part of the potential drop, is across the ITO/CNT and Pt/CNT interfaces. The two interfaces, however, provide different types of electrical contacts. Pt is deposited on top of the CVD-grown multiwalled CNTs, which typically consist of open graphene shells at the ends, see Z. W. Pan et al., Chem. Phys. Lett. 299, 97 (1999), enabling the metal to contact with all the graphene shell ends. At the ITO/CNT interface, however, CNTs grown from SiO₂ through the ITO layer provide electrical contacts primarily with the outermost graphene shell. Thus, it is expected that electrical transport is limited by carrier injection into the multiwalled CNTs at the ITO/CNT interface, and that the thermally activated I-V behavior at ξ<100 V cm⁻¹ in FIG. 4A corresponds to carrier injection into the outermost shell in contact with the ITO. This is consistent with prior work by A. Bachtold et al., Nature 397, 673 (1999), which showed that carrier transport occurs mainly through the outermost shell in multi-walled CNTs. Because irradiation by >1 keV ions welds adjacent nanotubes, the number of conducting pathways along outmost shells can be altered. At high fields, carriers can tunnel to inner shells immediately adjacent to the outermost one, resulting in field-dependent carrier injection and superlinear I-V behavior. The contribution of large-bandgap (e.g., >100 meV) semiconducting shells (i.e., diameter <20 nm), and inner metallic shells, see P. C. Collins et al., Science 292, 706 (2001), with similar diameter, is negligible due to the low carrier-tunneling probability arising from the low proximity to the metal layer. The inset of FIG. 3D depicts the two modes of carrier transport through the outermost shell and inner shells of each multiwalled nanotube. Carrier tunneling into the inner shells at high fields is depicted by the curved arrows and curvy lines in the inset of FIG. 3D.

The electrical characteristics of the Pt/CNT/ITO/SiO₂/Si(001) stacks was measured at room temperature (23° C.) and are shown in FIGS. 4A-C. The overall characteristics of the differential conductance (G=dI/dV) plotted as a function of applied voltage V₀ (see FIG. 4B) are essentially symmetrical about V₀=0, indicating that the test-device is non-rectifying. The small asymmetry observed is likely due to different top and bottom electrodes. These results indicate the absence of a Schottky barrier and represent carrier transport along CNTs in the bundle across the contacts. Fe particles, whose work function is ˜4.5 eV, are unlikely to significantly alter the electrical properties, since Fe is likely to form an ohmic contact with the CNTs (work functions of CNTs are ˜5-5.2 eV). For |V₀<˜1 V (electric field ξ<˜100 Vcm⁻¹ across 100-μm-thick CNT bundles) G is in the range of 1.5-3 mS for different measurements, yielding an effective resistance R_{eff}˜300-600 Ω. The weak dependence of G on ξ is typical of ohmic contacts. For ξ>˜100 V/cm, G α|V₀|^{0.8}, indicating non-ohmic behavior. FIG. 4C shows superlinear transport behavior above a critical electric field (e.g., 300 Vcm⁻¹). Such transitions could be used for switching in CNT-based devices (e.g., switching devices comprising CNT gate electrodes and high-k dielectric oxide template layers). Similar super-linear characteristics observed in individual single- and multi-walled CNTs have been attributed to phonon-assisted or thermally-activated carrier emission or low-temperature tunneling, see Z. Yao et al., Phys. Rev. Lett. 84, 2941 (2000); R. Martel et al., P. Avouris, Phys. Rev. Lett. 87, 256805 (2001), suggesting that the results represent the collective behavior of the aligned CNTs behaving as parallel resistors. Considering n CNTs in parallel per unit electrode area, with each CNT contributing a resistance Rᵢ, R_{eff} can be described by

$$1 / {R}_{eff} = {\sum }_{i = 1}^{n} 1 / {R}_{i} .$$

Here, n˜10 cm^{˜2}, yielding Rᵢ˜10¹²Ω, which is about 6 orders of magnitude higher than the reported contact resistance of ˜MΩ in Pt contacted individual CNTs. See G. Ramanath et al., J. Appl. Phys. 85, 1961 (1999). The high resistance is likely due to the CNT being longer than the electron wavefunction coherence length hindering ballistic charge transport and not all CNTs are being efficiently contacted. Contact efficiency at the CNT/template interface may be improved by ion bombardment.

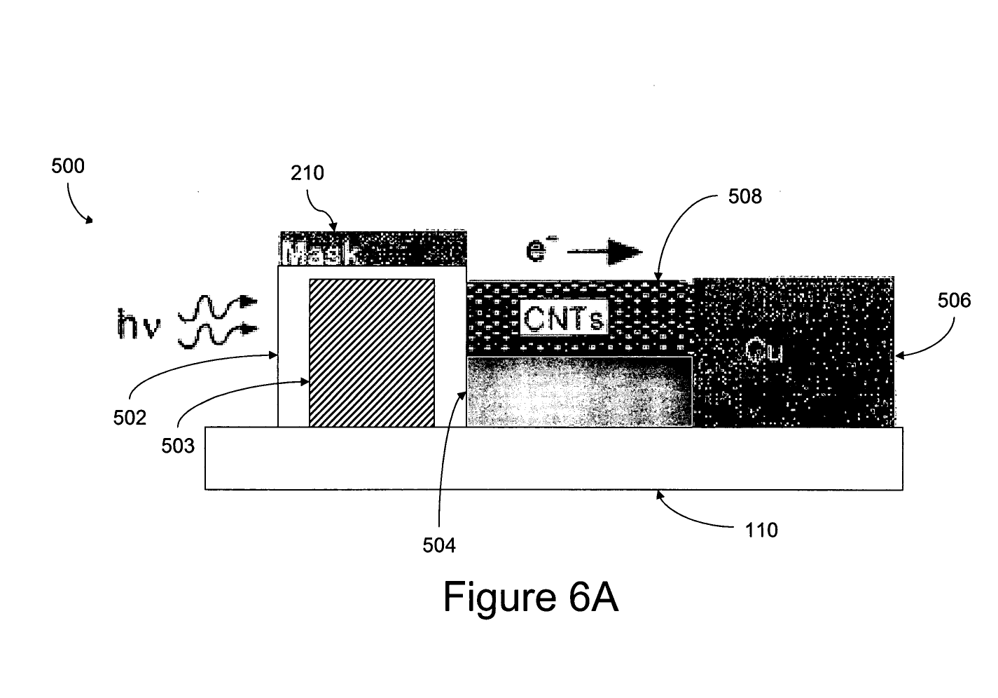

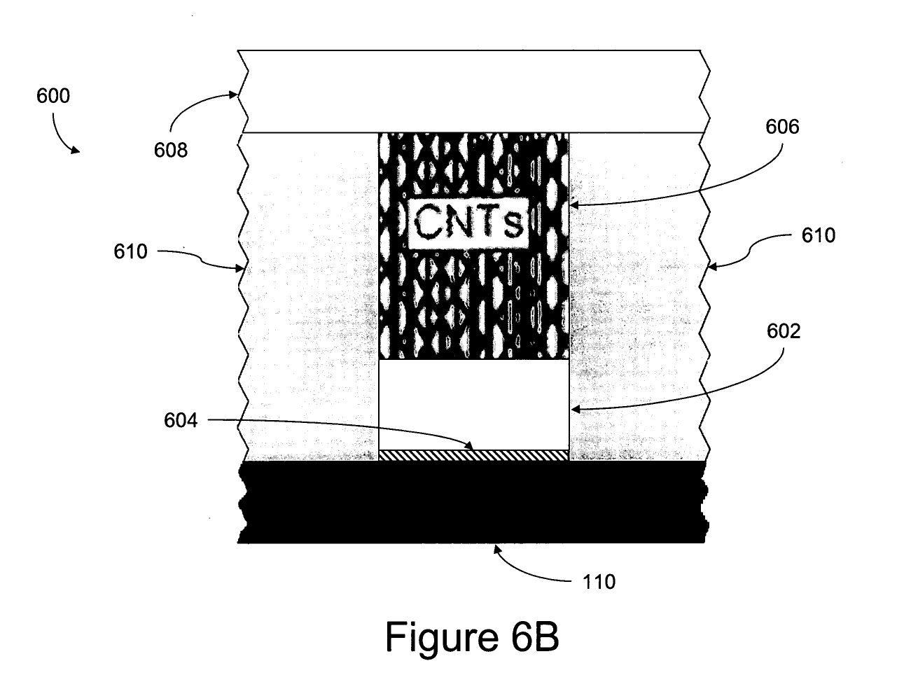

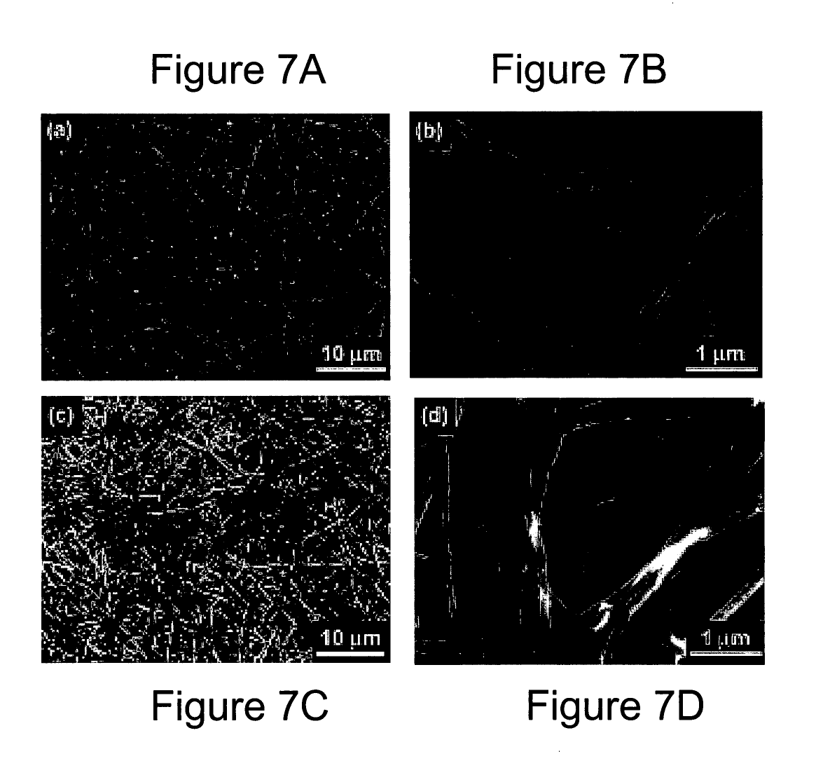

Electrical measurements were performed on the Pt/CNT/ITO/SiO₂/Si(001) stacks between 23 and 85° C. The results are summarized in FIGS. 5A-C. For ξ<˜100 V cm⁻¹, the conductivity (σ=J/ξ where J is the current density) shows an exponential temperature dependence (see FIG. 5A) described by σ=σ₀,

$$exp [ \frac{φ}{{k}_{B} T} ] ,$$

where σ₀, is a constant, and φ=100±10 meV, indicating thermally-activated carrier generation and/or transport. For ε>˜100 V cm⁻¹, σ is dependent on both ε and T, introducing an additional ε-dependent term in the exponent. FIG. 5B shows that the conductivity is exponentially dependent on ε^{1/2} at high fields. From these results, the overall transport behavior over the entire ε range can be described by the Poole-Frenkel (PF) model which involves field-assisted carrier emission above a threshold field. The PF model is given by, σ=σ₀,

$$exp [ \frac{{E}_{A}}{{k}_{B} T} ]$$

the ξ-dependent activation energy E_{A}=φ−β\sqrt{ξ,}β=(e³/πε₀ε) and ε is the dielectric constant of the transport medium. E_{A}, measured from the slope of the field-dependent portion of 1nσ vs. 1/k_{B}T plots, varies linearly with \sqrt{ε} (see FIG. 5C) and yields the value of φ=100±10 meV at ε=0, confirming the validity of the PF model used to describe the results herein. On calculation, β˜5.4×10⁻²⁴ Jm^{1/2}V^{-1/2} corresponds to an average ε˜5. This value is within the range of theoretically predicted dielectric constant of cylindrical graphene shells with zig-zag structure, indicating that the semiconducting shells in the CNTs of the present embodiment also participate in carrier transport. See L. X. Benedict et al., Phys. Rev. B 52(11), 8541 (1995); R. Krupke et al., Science 301, 344 (2003); F. Leonard & J. Tersoff, Appl. Phys. Lett. 81(25), 4835 (2002). Electrical measurements of ITO films on SiO₂ (not shown) in the same temperature range revealed temperature-independent ohmic behavior, indicating that the above thermally-activated ohmic and PF behavior is not due to ITO.

While the absence of a Schottky barrier in FIGS. 4A-C is surprising, it is not entirely unexpected due to carrier injection occurring predominantly into CNTs that have an outer metallic shell, and the overlapping work functions of ITO, the CNTs, and Pt, which are all in the range of 5.0-5.5 eV. In another embodiment of the invention, the materials of the contacting layer and/or template layer are chosen such that the work functions of the various layers do not overlap with that of the CNTs. In another embodiment, the work function of the template layer material (e.g., ITO) is altered (e.g., from 4.7 to ˜6 eV) by doping with other materials (e.g., Ga, Zn) to enable Schottky barrier formation. The introduction of a Schottky barrier in the electrical contact between the template layer and CNTs may be utilized in rectifying devices. Alternatively, residual amounts of carbide-forming metal dopants (e.g., Ti, Nb) are added to tailor the interface barrier characteristics via interfacial reaction leading to nanoparticle formation, while retaining optical transparency of the ITO layer. For instance, CNTs grown on templates of optically-transparent electrically-conducting oxides may be used in Schottky devices for THz detection, for instance in photodetector devices.

FIG. 6A is a schematic illustration of a photodetector device 500 according to an embodiment of the present invention. A substrate 110 contains an optically-transparent electrically-conducting oxide layer 502 that covers the surfaces of a SiO₂ structure 503, a low-k interlevel dielectric structure 504, and a metal contact structure 506. The metal contact structure 506 material is optionally Cu. Transparent conducting oxides include ZnO and ITO. Optionally, the work function of the transparent conducting oxide is altered, for instance by the addition of Ga or Zn dopants, to enable Schottky barrier formation. A mask layer 210 is optionally deposited on at least one surface of the oxide layer 502 in order to prevent CNT growth normal to at least one surface of the oxide structure. Preferably, the mask layer 210 covers the top surface and three side surfaces of the oxide layer 502, which is preferably cubic in shape, such that nanotube growth occurs parallel to both the substrate 110 and the low-k interlevel dielectric structure 504. Aligned CNTs 508 continue to grow normal to the sidewall of the oxide template 503, through the pores of the oxide layer 502, until the CNTs arrive at the metal contact structure 506. Optionally, the CNTs are bombarded with ions (>1 keV) to modify the surfaces and/or tailor the properties of the CNTs, for instance to anneal defects or to modify the nature of the CNT/oxide interface. For instance, ion bombardment of the CNT/oxide interface may tailor the contact and introduce a Schottky barrier between the oxide layer 502 and the CNTs 508, thus allowing fast switching at microwave frequencies (GHz and THz). Carrier transport along the CNTS 508 and between the ITO/CNT and CNT/Cu interfaces allows optical signals to be translated into electrical signals, thus facilitating photon detection for on-chip optoelectronic communication. In one embodiment, the substrate 110 is transparent to the incident phonons such that the incident phonons impinge upon the optically-transparent electrically-conducting oxide layer 502 through the underlying substrate 110.

FIG. 6B is a schematic illustration of a portion of a field-effect device 600 according to an embodiment of the present invention. The Si(001) substrate 110 is patterned with a high-k dielectric structure 602, which serves as the gate oxide of the field-effect device 600. High-k dielectrics include HfO₂, Ta₂O₅, and binary/ternary ferroelectric materials such as BaTiO₃. Preferably, the dielectric structure 602 is sufficiently porous and thin to allow precursor diffusion to an optional underlying SiO₂ deposited template layer or, alternatively, to an interfacial SiO₂ template layer 604 disposed on the substrate 110, such that aligned CNTs 606 grow normal to the substrate 110 surface and extend through the pores of the high-k dielectric structure 602. The CNTs 606 serve as the gate electrode of a field effect transistor which is connected to an overlying gate contact layer 608, such as an metal layer (i.e., copper, aluminum, their alloys, etc.) or a highly doped polysilicon layer. For a field effect transistor, the source, drain and channel regions are formed in the semiconductor substrate 110, which can be a semiconductor wafer or a semiconductor layer over a different substrate material. The dielectric structures 602 and 604 function as the gate dielectric of a MOS-type field effect transistor. For a very thin dielectric structure 604, such as an interfacial oxide, the transistor may take on MESFET-type characteristics due to the penetration of the nanotubes through the dielectric structure 602. The CNTs 606 form a plug that fills a space, referred to as a via, surrounded by a dielectric layer 610, such as a low-k interlevel dielectric layer, including silicon oxide, silicon nitride, etc. Thus, the CNTs 606 may serve as parallel low-resistance ballistic conduction pathways and decrease the effective via resistance, allowing the possibility of decreasing the line-width to the diameter of a single nanotube. Optionally, the CNTs are bombarded with ions (>1 keV) to modify the surfaces and/or tailor the properties of the CNTs, for instance to anneal defects or to modify the nature of the CNT/oxide interface. In another aspect of the invention, the CNTs provide high-speed switching, sensing, and actuation in CNT-based field-effect devices. For instance, the surface of the CNTs are chemically functionalized, for instance by local ion bombardment, to allow detection of chemical species in CNT field-effect sensors. In another embodiment, the unique thermal properties of CNTs, for instance the inverse temperature gradients of certain CNT/oxide structures, are utilized as thermal conductivity pathways to allow for device cooling.

In another embodiment, CNTs are crosslinked by irradiation with keV ions. FIGS. 7A-D are SEM images of CNT bundles before and after large-scale ion bombardment across the surface of the CNT bundles. Large scale assemblies of welded CNTs were made by the following method. Irradiation with 5 keV Ar⁺ ions was carried out on drop-coated CNT films on Si(001) substrates in an ultra-high vacuum chamber (base pressure of 10⁻⁸ Torr) fitted with a Perkin-Elmer model 04-303 differential ion gun. In one aspect of the invention, the CNTs were irradiated with ˜10¹³ to 10¹⁷ ions cm⁻² of 4 and 5 keV Ar⁺ions by rastering a 100 μm diameter beam, at a beam current at 25 μA, across ˜1-10 mm² fields. Irradiation with Ga⁺ ions under similar conditions achieved similar results, suggesting that the chemical species does not have a significant effect on defect creation characteristics in this ion energy window. Thus, ions other than Ar ions may be used. FIGS. 7A-B and 7C-D show the drop-coated mats before and after ion bombardment, respectively. Whereas the bundle before bombardment is comprised of individual multiwalled nanotubes; the bundle afterward is a single, dense structure of networked multiwalled nanotubes that are welded at substantially every visible intersecting nanotube-nanotube location. Rather than being held together by physical bonds (e.g., van der Waals forces), the multiwalled nanotubes are welded to create chemical bonds (e.g., covalent bonds). These features suggest that ion irradiation with keV ions over areas up to macroscopic scales is an efficient means of welding nanotubes or nanotube-bundles before or after dispersion or integration in polymer blends or composites. The interconnected CNT structure is expected to possess enhanced mechanical, thermal, and/or electrical properties compared to non-irradiated bundles. Additionally, ion bombardment may alter the nature of the contact between the CNT structure and an electrical contact layer. For instance, large-scale ion bombardment at the CNT/ITO interface may introduce a Schottky barrier in the electrical junction. In the case of aligned CNTs grown normally to template structures, the multiwalled nanotubes are in closer proximity to each other than they are in a drop-coated mat. Ion bombardment of the aligned CNTs, therefore, has a different effect in terms of the number of welded tubes per unit area.

What is claimed is:

1. A structure, comprising:
a substrate comprising a first surface which is not coated with a metal catalyst layer suitable for nucleating carbon nanotube growth;
a porous metal oxide layer located over the first surface; and
a plurality of carbon nanotubes which are disposed on the first surface and which extend through pores in the porous metal oxide layer.

2. The structure of claim 1, wherein:
the first surface comprises a template structure which is suitable for carbon nanotube growth by a floating catalyst method; and
the carbon nanotubes comprise multi-walled carbon nanotubes which are controllably aligned in a direction substantially perpendicular to the first surface.

3. The structure of claim 2, wherein:
the first surface comprises a surface of a silicon substrate or a surface of a silicon oxide layer located over the substrate; and
the metal oxide layer comprises a metal oxide layer that is thermodynamically less stable than silicon oxide.

4. The structure of claim 3, wherein the metal oxide layer comprises as at least one of ITO, AZO, In₂O₃, SnO₂, ZnO, PbO₂, SeO₂, NbO₂, Ni₂O₃, MoO, Cu₂O, HfO₂, Ta₂O₅, and BaTiO₃.

5. The structure of claim 1, wherein the metal oxide layer has a thickness of less than 120 nm.

6. The structure of claim 1, wherein the metal oxide layer comprises an electrically conductive electrode which electrically contacts the plurality of carbon nanotubes.

7. The structure of claim 6, further comprising a second electrode electrically contacting upper portions of the plurality of carbon nanotubes.

8. The structure of claim 1, wherein the plurality of carbon nanotubes comprise:
a first set of carbon nanotubes which are controllably aligned in a first direction substantially perpendicular to a first portion of the first surface; and
a second set of carbon nanotubes which are controllably aligned in a second direction substantially perpendicular to a second portion of the first surface, wherein the first direction is different from the second direction, and the first portion of the first surface is not parallel to the second portion of the first surface.

9. The structure of claim 2, wherein:
the metal oxide layer comprises an optically transparent, electrically conducting metal oxide layer; and
the structure comprises a Schottky junction of a photodetector device.

10. The structure of claim 2, wherein:
the metal oxide layer comprises a gate oxide layer of a field effect transistor; and
the plurality of carbon nanotubes comprise conduction pathways.

11. The structure of claim 2, wherein the plurality of carbon nanotubes comprise a thermal conductivity pathway of a thermal management device.

12. The structure of claim 1, wherein the plurality of carbon nanotubes comprise interconnected nanotubes, wherein adjacent nanotubes are chemically welded at locations where adjacent nanotubes overlap.

13. A method of making a carbon nanotube structure, comprising:
providing a substrate comprising a first surface and a porous metal oxide layer formed over the first surface; and
selectively growing a plurality of carbon nanotubes on the first surface through pores in the metal oxide layer by using a floating catalyst deposition method.

14. The method of claim 13, wherein the floating catalyst deposition method comprises providing xylenes and ferrocene onto the first surface in a chemical vapor deposition apparatus.

15. The method of claim 13, wherein:
the first surface comprises at least a first and a second portion oriented in different directions from each other; and
the carbon nanotubes are aligned in a different direction on the respective first and second portions of the template structure.

16. The method of claim 13, further comprising irradiating the carbon nanotubes with ions comprising an energy greater than 1 keV.

17. The method of claim 13, wherein the metal oxide layer comprises as at least one of ITO, AZO, In₂O₃, SnO₂, ZnO, PbO₂, SeO₂, NbO₂, Ni₂O₃, MoO, Cu₂O, HfO₂, Ta₂O₅, and BaTiO₃.

18. The method of claim 13, wherein the metal oxide layer has a thickness of less than 120 nm.

19. The method of claim 13, wherein the metal oxide layer comprises an electrically conductive electrode which electrically contacts the plurality of carbon nanotubes.

20. The method of claim 19, wherein:
the metal oxide layer comprises an optically transparent, electrically conducting metal oxide layer; and
the structure comprises a Schottky junction of a photodetector device.

21. The method of claim 13, wherein:
the metal oxide layer comprises a high-k dielectric gate insulating layer of a field effect transistor; and
the plurality of carbon nanotubes comprise a gate electrode of the field effect transistor.

22. A method of making a carbon nanotube structure, comprising:
providing a mat comprising a plurality of carbon nanotubes;
irradiating the plurality of carbon nanotubes with a beam of ions comprising an energy greater than 1 keV; and
rastering the beam over an area equal to or greater than 1 mm² to at least one of weld or cross link the plurality of carbon nanotubes of the mat.

23. The method of claim 22, wherein the ions comprise ions of gallium or argon and the carbon nanotubes comprise multi-walled carbon nanotubes.
